(19) United States
(12) Patent Application Publication
(10) Pub. No.: US 2016/0268016 A1
(43) Pub. Date: Sep. 15, 2016

(54) Dissipative Article and Process of Producing Dissipative Article

(71) Applicant: Tyco Electronics Corporation, Berwyn, PA (US)

(72) Inventors: Hyo Chang Yun, Saratoga, CA (US); Lei Wang, San Jose, CA (US); Peter J. Dutton, Fremont, CA (US)

(73) Assignee: Tyco Electronics Corporation, Berwyn, PA (US)

(21) Appl. No.: 14/657,998

(22) Filed: Mar. 13, 2015

(51) Int. Cl. H01B 1/24; H01B 13/00; B64G 1/22

(52) U.S. Cl. CPC H01B 1/24; B64G 1/226; H01B 13/0033

(57) ABSTRACT

Static dissipative articles and processes of producing static dissipative articles are described. The static dissipative article includes a conductor and a dissipative coating over the conductor, the dissipative coating including a polymer matrix and between 0.1 and 10%, by weight, conductive nano-carbons homogenously distributed with the polymer matrix. The dissipative coating has a resistivity of between 10⁶ and 10¹⁴ ohm·cm, and the conductive-nano-carbons have an aspect ratio of at least 100. The process of producing a coated article includes blending a polymer powder with between 0.1 and 10%, by weight, conductive nano-carbons to form a micron-level homogenous compound, and extruding the compound onto a conductor to form a dissipative coating over the conductor.

### FIELD OF THE INVENTION

The present invention is directed to dissipative articles and processes of producing such articles. More particularly, the present invention is directed to conductors with dissipative coatings formed thereon.

### BACKGROUND OF THE INVENTION

Polymers have been widely used as a wire insulation due to their non-conductive nature. However, polymers generally exhibit a risk of electrostatic discharge when the electric field strength from electrostatic charging is higher than the dielectric strength of the polymer insulation. For example, it has been found that unusually high electrostatic charging may result from either tribo-electron or external radiation.

One method of reducing the risk of electrostatic discharge (ESD) includes wrapping a metallic film or ESD coating around the polymer insulation. However, this adds weight to the wire and typically requires secondary engineering work. Another method includes the addition of carbon black to the polymer coating. In general, carbon black particles are apt to agglomerate into secondary large particles, which result in local inhomogeneity. Due to the local inhomogeneities, small regions of polymer exist that do not contain any carbon black. Under the influence of charged particles the polymer regions without carbon black can become charged, eventually resulting in electrostatic discharge.

A coated article and process of producing a coated article that show one or more improvements in comparison to the prior art would be desirable in the art.

### BRIEF DESCRIPTION OF THE INVENTION

In an embodiment, a static dissipative article includes a conductor and a dissipative coating over the conductor, the dissipative coating including a polymer matrix and between 0.1 and 10%, by weight, conductive nano-carbons homogenously distributed with the polymer matrix. The dissipative coating has a resistivity of between 10⁶ and 10¹⁴ ohm·cm, and the conductive nano-carbons have an aspect ratio of at least 100.

In another embodiment, a static dissipative article for space applications includes a wire and a dissipative coating over the wire, the dissipative coating comprising a thermoplastic polymer matrix and between 0.1 and 10%, by weight, conductive nano-carbons homogenously distributed with the thermoplastic polymer matrix. The dissipative coating has a resistivity of 10¹⁰ ohm·cm, and the conductive nano-carbons have an aspect ratio of at least 100.

In another embodiment, a process of producing a coated article includes blending a polymer powder with between 0.1 and 10%, by weight, conductive nano-carbons to form a micron-level homogenous compound, and extruding the compound onto a conductor to form a dissipative coating over the conductor.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a section view of a coated article.

FIG. 2 is a graphical representation of volume resistivity in ohm·cm shown on the y-axis from 10 to 10¹⁷ and concentration of nano-carbons in volume percent shown on the x-axis of an embodiment according to the disclosure.

FIG. 3 is a graphical representation of volume resistivity in ohm·cm shown on the y-axis as a function of temperature shown on the x-axis.

Wherever possible, the same reference numbers will be used throughout the drawings to represent the same parts.

### DETAILED DESCRIPTION OF THE INVENTION

Provided are a coated article and process of producing the coated article. Embodiments of the present disclosure, for example, in comparison to concepts failing to include one or more of the features disclosed herein, permit increases in insulation of electronic components, reduce electrostatic charging of insulation, permit dissipation of electrostatic charging in insulation at an early stage, permit dissipation of electrostatic charge while maintaining insulating resistance, provide micron-level homogeneity of resistivity, permit the formation of electrostatic discharge free insulation, permit reduced agglomeration of conductive carbon particles within polymer coatings, permit other suitable advantages and distinctions, and permit combinations thereof.

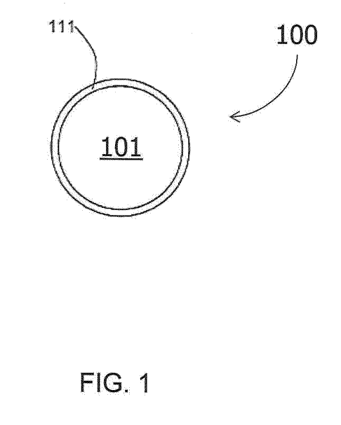

Referring to FIG. 1, in one embodiment, a coated article 100 includes a conductor 101 and a coating 111 provided over the conductor 101. The conductor 101 includes any conductive material suitable for receiving a coating. Suitable conductive materials include, but are not limited to, copper, annealed copper, aluminum, or a combination thereof. Suitable geometries include, for example, a round wire, a square wire, a box, any other desired geometrical shape, or a combination thereof. For example, one suitable conductor includes a 24 AWG copper wire. Another suitable conductor includes a conductive box. Other suitable conductors include wires having differing geometries and/or gauges, conductive articles having various geometries, or a combination thereof.

The coating 111 extends around at least a portion of the conductor 101. In one embodiment, the coating 111 includes a dissipative coating with a polymer material and conductive particles. In another embodiment, the coating 111 includes a thickness of between 150 and 400 μm, between 200 and 300 μm, between 230 and 250 μm, or any combination, sub-combination, range, or sub-range thereof.

The polymer material forms a polymer matrix having the conductive particles distributed therein. In another embodiment, the polymer material includes a non-conductive polymer material, such as, but not limited to, a thermoplastic. In a further embodiment, the polymer material includes a fluoropolymer, such as polyvinylidene fluoride (PVDF), copolymers of vinylidene fluoride (VDF) and hexafluoropropylene (HFP), terpolymers of VDF, HFP, and tetrafluoroethylene (TFE), fluorinated ethylene propylene, ethylene tetrafluoroethylene (ETFE), polytetra fluoroethylene, other suitable fluorinated matrices compatible with the conductive particles, or a combination thereof. Other suitable non-conductive matrices include, but are not limited to polyethylene, polypropylene, ethylene-vinyl acetate, polyamide, neoprene, polyether ether ketone (PEEK), or a combination thereof.

The conductive particles are or include conductive carbons, such as, but not limited to, carbon black, carbon nanotube, graphene, other suitable conductive carbons compatible with the polymer material, or a combination thereof. Suitable morphologies for the conductive particles include, but are not limited to, dendrites, flakes, fibers, tubes, and spheres. When added to the polymer material, the conductive particles increase a conductivity of the coating 111. For example, in one embodiment, the conductive particles are added to the polymer material to provide an electrical volume resistivity of the coating 111 within the range of 10⁶ and 10¹⁴ ohm·cm, 10⁶ and 10¹⁰ ohm·cm, 10⁸ and 10¹⁰ ohm·cm, or any combination, sub-combination, range, or sub-range thereof. As used herein, the term “resistivity” refers to measurable values determined upon formation of the coating 111 and does not refer to values measured prior to application of high shear, as discussed in detail below.

An amount of the conductive particles added to the polymer material is selected to control the resistivity of the coating 111 within the above ranges to form a dissipative coating capable of dissipating electrostatic charges. In one embodiment, the conductive particles are added to the coating 111 at a percentage that is less than the percolation threshold of the specific conductive particles. As will be appreciated by those skilled in the art, the percolation threshold differs between different types of conductive particles, and as such, the percentage of conductive particles in the coating is selected based upon the specific type of conductive particle used. For example, conductive carbons having comparatively higher aspect ratios, which exhibit a lower percolation threshold, are added at a lower percentage during formation of the coating 111 as compared to conductive carbons having comparatively lower aspect ratios, which exhibit a higher percolation threshold.

In one embodiment, the conductive particles form between 0.1 and 10%, by weight, of the coating 111. In another embodiment, the conductive particles have an aspect ratio of at least 100. The term “aspect ratio,” as used herein, refers to a proportional relationship of width to length of the particle. As will be appreciated by those skilled in the art, the percentage and/or aspect ratio of the conductive particles in the coating 111 will vary based upon the specific type of particles and/or the properties of the conductive particles. For example, in a further embodiment, nano-carbons, such as carbon nanotubes and/or graphene, form between 0.1%, by weight, and 2%, by volume, of the coating 111. Including at least 0.1%, by weight, of the nano-carbons provides a sufficient amount of the conductive particles in the coating 111 to efficiently dissipate electrostatic charge. Additionally, including at most 2%, by volume, of the nano-carbons maintains an insulation resistance of the coating 111.

Alternatively, in some embodiments, more than 2%, by volume, of the conductive particles is included without increasing a conductivity of the coating 111 to a level which reduces the insulation resistance of the coating 111. For example, other conductive carbons, such as carbon black, are added at higher percentages of at least 5%, by volume. Furthermore, other properties of the conductive particles, such as, but not limited to, conductive particle shape, conductive particle size, or a combination thereof, affect the conductivity of the conductive particles and are optionally adjusted to form the dissipative coating.

The coated article 100 including the coating 111 facilitates dissipation of charging particles (i.e., flux). In one embodiment, the coated article 100 is configured for space applications. For example, in another embodiment, the coated article 100 includes a wire or a box formed from a PEEK-based polymer material with conductive carbon filler.

Preparing the coated article 100 includes providing the conductor 101, forming a coating mixture, and applying the coating mixture to the conductor 101. In one embodiment, forming the coating mixture includes mixing the conductive particles with a polymer powder. The mixing of the conductive particles with the polymer powder includes any suitable mixing method such as, but not limited to, melt blending, extruding, powder blending, or a combination thereof. For example, in another embodiment, forming the coating mixture includes melt blending nano-carbons and ethylene tetrafluoroethylene powder at 280° C., and/or powder blending the nano-carbons and ethylene tetrafluoroethylene powder for 1 minute. In a further embodiment, the ethylene tetrafluoroethylene powder includes an ultra fine powder having an average particle size of 5 μm or less. In addition to the conductive particles, forming the coating mixture optionally includes mixing one or more additives with the polymer powder. Suitable additives include, but are not limited to, an E-Beam crosslinking agent, an anti-oxidant, an acid scavenger, or a combination thereof. As shown in Table 1 below, the composition of the coating material is adjusted based upon desired conductivity and/or the inclusion of additives within the mixture.

TABLE 1

| | EXP 1 | EXP 2 | EXP 3 | Note |
|---|---|---|---|---|
| Description | 0.4% CNT | 0.3% CNT | 0.2% CNT | |
| | in ETFE | in ETFE | in ETFE | |
| M/B | 12.41 | 9.30 | 6.19 | 3% CNT |
| | | | | in ETFE |
| ETFE | 80.29 | 83.40 | 86.51 | |
| E-beam cross- | 7.00 | 7.00 | 7.00 | |
| linking agent | | | | |
| Anti-oxidant | 0.30 | 0.30 | 0.30 | |
| Total | 100.00 | 100.00 | 100.00 | |

In one embodiment, after forming the coating mixture, the applying of the coating mixture to the conductor 101 includes compressing the coating mixture to form a film, then laminating the film onto the conductor 101. Additionally or alternatively, the applying includes extruding the coating mixture directly onto the conductor 101, spraying the coating mixture onto the conductor 101, injecting the coating mixture to form the coated article 100, or a combination thereof. In another embodiment, the applying of the coating mixture forms the coating 111 over at least a portion of the conductor 101. In one example, the coating mixture is extruded over a wire conductor to form the coated article 100. In another example, the coated article 100 includes a composite box, and is formed through injection, spray coating, and/or lamination. In a further embodiment, preparing the coated article 100 optionally includes processing the coating material on the conductor 101 to form the coating 111. For example, in one embodiment, the process includes the application of radiation, such as electron-beam crosslinking, to the coating material applied over the conductor 101.

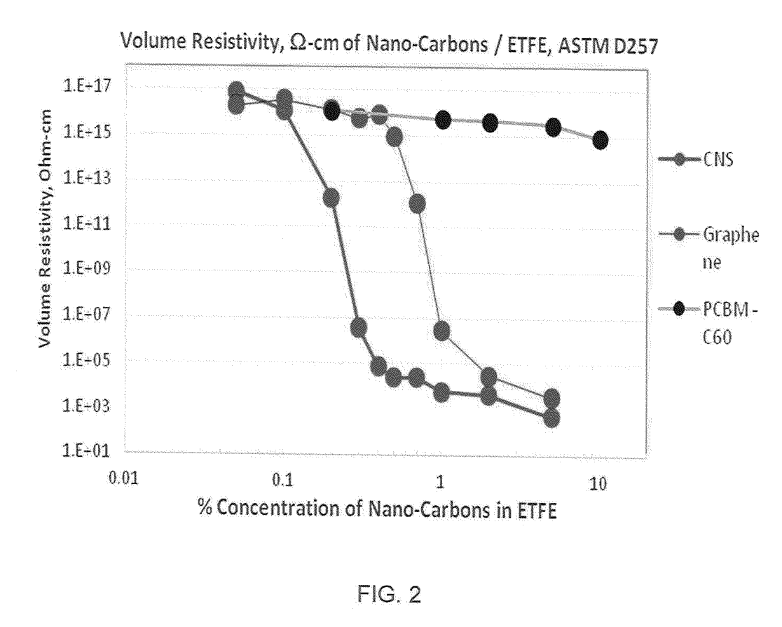

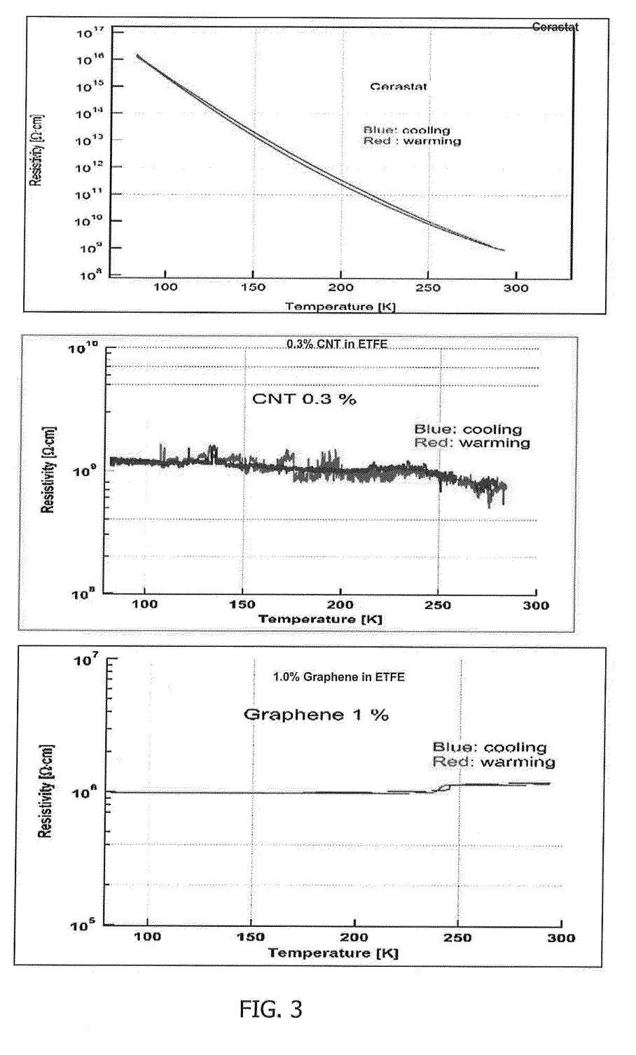

The compressing of the coating mixture and/or the extruding of the coating mixture applies a high shear to the coating mixture, reducing or eliminating agglomeration of the conductive particles into larger secondary particles. By reducing or eliminating agglomeration of the conductive particles, the methods disclosed herein reduce or eliminate local inhomogeneity in the coating 111. The reducing or eliminating of agglomeration also provides a micron-level homogeneity of resistivity that dissipates charge to eliminate or substantially eliminate electrostatic charge accumulation and discharge from the coating 111. For example, FIG. 2 illustrates volume resistivity of the coating 111 plotted as a function of volume percent of nano-carbons, as measured by using a 4-point probe method per ASTM D257. Additionally, FIG. 3 shows volume resistivity of ETFE and nano-carbon compounds measured with varying temperature from −170° C. to 25° C., under a vacuum of 10⁻⁶ torr. As used herein, the term “micron-level homogeneity” refers to the coating 111 including only minor fluctuations in conductive particle concentration at a size of less than a few μm, with no agglomeration of conductive particles greater than 5 μm.

In one embodiment, conductive particles having a comparatively higher aspect ratio, such as carbon nanotubes and/or graphene, form the coating 111 having a lower viscosity as compared to conductive particles having a comparatively lower aspect ratio, such as carbon black. In another embodiment, the lower viscosity provided by carbon nanotubes and/or graphene increases an ability to reduce or eliminate agglomeration of the conductive particles, which increases homogeneity within the coating 111 and/or coating efficiency of the process.

### Example

The invention is further described in the context of the following example which is presented by way of illustration, not of limitation. In the example, the process was carried out in accordance with one or more of the embodiments disclosed herein.

In one example, coated articles were formed by coating copper (Cu) conductor wires with an electrostatic discharge free, dissipative, nano-carbon coatings. The coated articles were prepared through extrusion, then delivered to Jet Propulsion Laboratory (JPL, Pasadena Calif.) to test the electrostatic discharge performance.

To test the electrostatic discharge performance, a high energy electron beam (80-100 KeV) with electron flux (1-2 nA/cm2) was applied to the coated articles for a 2 hour interval, during which the voltage pulse (discharge) and number of discharges were measured with on-time monitoring. The voltage pulse and number of discharges of the coated articles were then compared with the voltage pulse and number of discharges measured from traditional wires coated with carbon black based dissipative coating. The coated articles showed a 90% ( 9/10) decrease in voltage pulse and an 83% (⅚) decrease in the number of discharges as compared to the traditional wires. Based upon the voltage pulse and number discharge measurements, the coated articles including the nano-carbon base dissipative coating meet the ESD requirement for space wire, i.e., Human Body Model 1A classification.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

What is claimed is:

1. A static dissipative article, comprising:
a conductor; and
a dissipative coating over the conductor, the dissipative coating comprising:
a polymer matrix; and
between 0.1 and 10%, by weight, conductive nano-carbons homogenously distributed with the polymer matrix;
wherein the dissipative coating has a resistivity of between 10⁶ and 10¹⁴ ohm·cm; and
wherein the conductive nano-carbons have an aspect ratio of at least 100.

2. The static dissipative article of claim 1, wherein the polymer matrix comprises a fluoropolymer.

3. The static dissipative article of claim 2, wherein the polymer matrix comprises ethylene tetrafluoroethylene.

4. The static dissipative article of claim 3, wherein the ethylene tetrafluoroethylene comprises an average particle size of 5 μm.

5. The static dissipative article of claim 1, wherein the conductive carbons includes a component selected from the group consisting of carbon nanotube and graphene.

6. The static dissipative article of claim 1, wherein the coating has a resistivity of between 10⁸ and 10¹⁰ ohm·cm.

7. The static dissipative article of claim 1, wherein the coated article is selected from the group consisting of a formed wire and a box.

8. The static dissipative article of claim 1, wherein the conductive carbons comprise nano-carbons.

9. The static dissipative article of claim 8, wherein the dissipative coating comprises up to 2% nano-carbons, by volume.

10. The static dissipative article of claim 9, wherein between 0.1%, by weight, and 2%, by volume, of the nano-carbons dissipates electrostatic charge and provides an insulation resistance.

11. The static dissipative article of claim 1, wherein the homogenously distributed conductive carbons provide a micron-level homogeneity of resistivity that dissipates charge and restricts electrostatic charge accumulation.

12. The static dissipative article of claim 1, wherein the conductive carbons are spherical.

13. A static dissipative article for space applications, comprising:
a wire; and
a dissipative coating over the wire, the dissipative coating comprising:
a thermoplastic polymer matrix; and
between 0.1 and 10%, by weight, conductive nano-carbons homogenously distributed with the thermoplastic polymer matrix;
wherein the dissipative coating has a resistivity of 10¹⁰ ohm·cm; and
wherein the conductive nano-carbons have an aspect ratio of at least 100.

14. A process of producing a static dissipative article, the process comprising:
blending a polymer powder with between 0.1 and 10%, by weight, conductive carbons to form a micron-level homogenous compound; and
extruding the compound onto a conductor to form a dissipative coating over the conductor.

15. The process of claim 14, wherein the conductor comprises a wire.

16. The process of claim 15, wherein the wire and the dissipative coating form an electrostatic-discharge-free wire.

17. The process of claim 14, wherein the polymer powder comprises ethylene tetrafluoroethylene having an average particle size of 5 μm.

18. The process of claim 14, wherein the conductive carbons includes a component selected from the group consisting of carbon nanotube and graphene.

19. The process of claim 14, wherein the resistivity is between 10⁶ and 10¹⁴ ohm·cm.

20. The process of claim 14, wherein the blending further comprises blending the polymer powder with an additive selected from the group consisting of an E-beam crosslinking agent, an anti-oxidant, an acid scavenger, and combinations thereof.
